(19) United States
(12) Patent Application Publication
(10) Pub. No.: US 2018/0235435 A1
(43) Pub. Date: Aug. 23, 2018

(54) SHOE CLEANING SYSTEM

(71) Applicant: Ronald Meredith, Anaheim, CA (US)

(72) Inventor: Ronald Meredith, Anaheim, CA (US)

(21) Appl. No.: 15/696,112

(22) Filed: Sep. 5, 2017

Related U.S. Application Data
(60) Provisional application No. 62/383,572, filed on Sep. 5, 2016.

(51) Int. Cl. A47L 23/02; B60J 5/04; B08B 5/02

(52) U.S. Cl. CPC A47L 23/02; B08B 5/02; B60J 5/0493

(57) ABSTRACT

A shoe cleaning system is a shoe cleaning system where high speed fans or air turbines are mounted within the doors of a vehicle that blow high speed air through adjustable direction louvers to blow mud, dirt, or debris off of the shoes of the user to keep the floor mats of the vehicle clean.

### CROSS-REFERENCE TO RELATED APPLICATION

The present application is related to and claims priority from prior provisional application Ser. No. 62/383,572, filed Sep. 5, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of shoe cleaning devices and more specifically relates to a shoe cleaning system for use with motor vehicles.

### 2. DESCRIPTION OF THE RELATED ART

Currently, there are more than 250 million cars, vans, pickups, and SUVs registered for use on America's roads and highways; and another 3 million commercial trucks. All of these vehicles require maintenance and cleaning to extend the useful life of the vehicle. Cleaning the vehicle includes regularly removing, shaking out, and brushing off the floor-mats to extend their life span. During use, automotive floor-mats collect dirt, mud, leaves, pine-straw and whatever the passengers and driver's shoes pick up from the ground and carry inside to the floor of the vehicle. Theoretically, if every driver and passenger took the time to brush off their shoes prior to getting into the vehicle, the mats would stay cleaner for much longer. Few motorists, however, go to such lengths. Even the most conscientious passengers and drivers find it very difficult to clean their shoes when the weather is wet and the ground is muddy. The vast majority of the time in these circumstances, getting the shoes clean enough to prevent mud, dirt, and other debris from clinging and ending up on the floor of the vehicle is just impractical. A practical solution is needed.

Various attempts have been made to solve the above-mentioned problems such as those found in U.S. Pat. No. 2,979,340 to Morrissey Carl H; U.S. Pat. No. 5,075,917 to George A. Wheat; and U.S. Publication No. 2014/0311523 to Patrick K. Best. None of the above inventions and patents, taken either singly or in combination, is seen to describe the invention as claimed.

Ideally, a shoe cleaning device should provide efficiency and convenience in cleaning shoes when entering a vehicle, and yet, would operate reliably and be manufactured at a modest expense. Thus, a need exists for a reliable shoe cleaning system for use with motor vehicles to avoid the above-mentioned problems.

### BRIEF SUMMARY OF THE INVENTION

In view of the foregoing disadvantages inherent in the known shoe cleaning device art, the present invention provides a novel shoe cleaning system for use with motor vehicles. The general purpose of the present invention, which will be described subsequently in greater detail, is to provide efficiency and convenience in cleaning shoes when entering a vehicle.

A shoe cleaning system for use with motor vehicles may comprise at least one air blowing motor adapted to be located within a respective door member of a motor vehicle and have at least one air hose that is adapted to be located within the respective door member of the motor vehicle that is attached to a respective air blowing motor and is adapted to receive air from the air blowing motor through a proximal end and exhaust air through a distal end thereof. At least one rotatable louver member is adapted to be connected to an interior surface of a respective door member of the motor vehicle.

The rotatable louver member is connected to the distal end of its respective air hose and is adapted to direct the air exhausting from the distal in a desired direction. A control member is adapted to be connected to the interior surface of the motor vehicle and is electrically connected to each of the air blowing motor(s) to turn on and off each one individually. When in use, a person can sit upon the seat within the motor vehicle with their feet still outside the motor vehicle and turn on a respective air blowing motor to clean their shoes before entering the motor vehicle.

The control member may be formed as a rotary knob having a plurality of settings adapted to control which of the air blowing motors is turned on or off. The settings include a driver's seat only mode and a driver's seat and passenger's seat mode.

Each air hose has an air hose extension attached to a middle section thereof and is adapted to receive air from the air blowing motor through the proximal end and exhaust air through a distal end thereof. There are two rotatable louver members adapted to be connected to the interior surface of the respective door member of the motor vehicle in a spaced fashion and are connected to respective distal ends of the air hose and air hose extension and are adapted to direct the air exhausting therefrom in two desired directions. The settings include a driver's seat only mode and a driver's seat and passenger seat mode. Each air blowing motor is preferably formed as a high-speed electric fan.

The combination of a motor vehicle and a shoe cleaning system may comprise a motor vehicle including a driver's door having an exterior panel member, an interior panel member, and an interior volume in between the exterior panel member and the interior panel member, at least one passenger's door with each one including an exterior panel member, an interior panel member, and an interior volume in between the exterior panel member and the interior panel member, at least one control console, and a shoe cleaning system.

The shoe cleaning system comprises a plurality of air blowing motors located within the interior volume of each of the doors, a plurality of air hoses located within the interior volume of each of the doors that are attached to respective air blowing motors and adapted to receive air from the air blowing motors through the proximal end and exhaust air through the distal end thereof.

There is at least one rotatable louver member connected to the interior surface of each of the doors and each the rotatable louver members are connected to the distal end of each respective air hose and is adapted to direct the air exhausting from the distal in a desired direction. A control member is connected to the interior surface of a control console and is electrically connected to each of the air blowing motors and is adapted to turn on and off each air blowing motor individually.

When in use, a person can sit upon the seat of a motor vehicle with their feet still outside the vehicle and turn on the respective air blowing motor to clean their shoes before entering the motor vehicle. The control member may be formed as a rotary knob having a plurality of settings adapted to control which air blowing motor is turned on or off. The settings include a driver's seat only mode and a driver's seat and passenger's seat mode.

Each air hose has an air hose extension attached to the middle section that is adapted to receive air from a respective air blowing motor through the proximal end and exhaust air through the distal end. There are two rotatable louver members connected to the interior surface of each door in a spaced fashion with the respective distal ends of the rotatable louver members each attached to respective air hoses. The air hose extensions are adapted to direct the air exhausting therefrom in two desired directions. Each of the air blowing motors is preferably formed as high-speed electric fans.

The present invention holds significant improvements and serves as a shoe cleaning system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, shoe cleaning system constructed and operative according to the teachings of the present invention.

FIG. 1 shows a perspective view illustrating a shoe cleaning system according to an embodiment of the present invention.

FIG. 2 is a diagram illustrating the shoe cleaning system according to an embodiment of the present invention of FIG. 1.

FIG. 3 is a perspective view illustrating the combination of a motor vehicle and a shoe cleaning system according to an embodiment of the present invention of FIG. 1.

FIG. 4 is a perspective view illustrating the louvers of the shoe cleaning system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a shoe cleaning device and more particularly to a shoe cleaning system for use with motor vehicles as used to improve the efficiency and convenience of cleaning shoes when entering a vehicle.

Generally speaking, a shoe cleaning system is a shoe cleaning system where high speed fans or air turbines are mounted within the doors of a vehicle that blow high speed air through adjustable direction louvers to blow mud, dirt, or debris off of the shoes of the user to keep the floor mats of the vehicle clean.

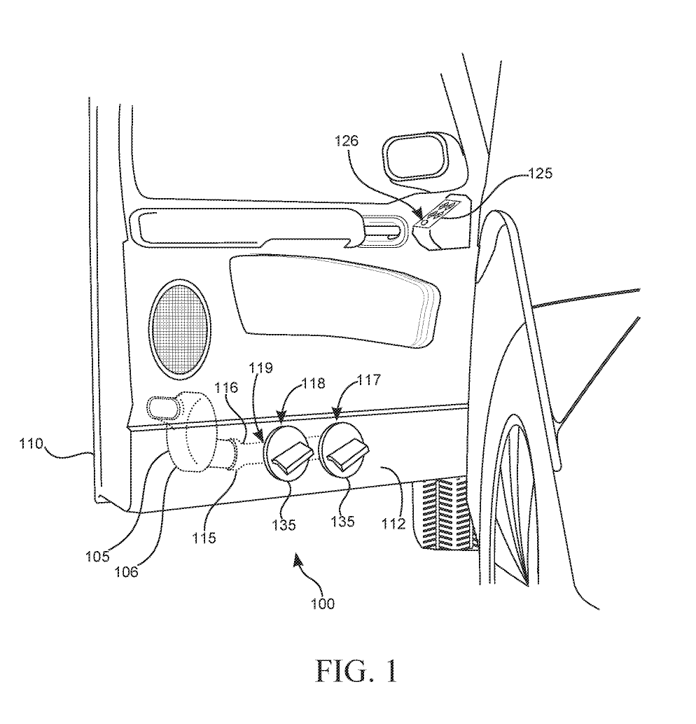

Referring to the drawings by numerals of reference there is shown in FIG. 1, a perspective view illustrating shoe cleaning system 100 according to an embodiment of the present invention.

Shoe cleaning system 100 for use with motor vehicle 205 may comprise at least one air blowing motor 105 adapted to be located within a respective door member 110 of motor vehicle 205 and have at least one air hose 115 that is adapted to be located within the respective door member 110 of motor vehicle 205 that is attached to a respective air blowing motor 105 and is adapted to receive air from air blowing motor 105 through proximal end 116 and exhaust air through distal end 117 thereof. At least one rotatable louver member 135 is adapted to be connected to interior surface 112 of a respective door member 110 of motor vehicle 205.

Each air hose 115 has air hose extension 118 attached to middle section 119 that is adapted to receive air from a respective air blowing motor 105 through proximal end 116 and exhaust air through distal end 117. There are two rotatable louver member 135 connected to interior surface 112 of each door member 110 in a spaced fashion with the respective distal end 117 of rotatable louver members 135 each attached to respective air hose 115. Air hose extensions 118 are adapted to direct the air exhausting therefrom in two desired directions. Each of air blowing motor 105 is preferably formed as high-speed electric fans 106.

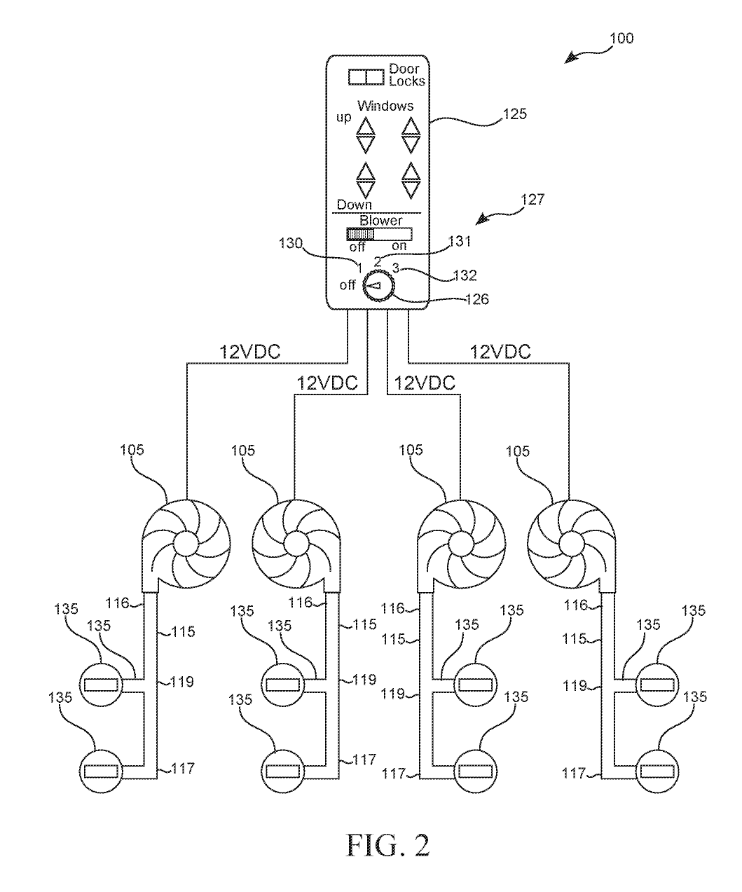

Referring now to FIG. 2, a diagram illustrating shoe cleaning system 100 according to an embodiment of the present invention of FIG. 1.

Control member 125 may be formed as rotary knob 126 having a plurality of settings adapted to control which of air blowing motors 105 is turned on or off. The settings include driver's seat only mode 130 and driver's seat and passenger's seat mode 131. A third option is passenger seats mode 132 only.

Each air hose 115 has air hose extension 118 attached to middle section 119 thereof and is adapted to receive air from air blowing motor 105 through proximal end 116 and exhaust air through distal end 117 thereof. There are two rotatable louver member 135 adapted to be connected to interior surface 112 of the respective door member 110 of motor vehicle 205 in a spaced fashion and are connected to respective distal ends 117 of air hoses 115 and air hose extensions 118 and are adapted to direct the air exhausting therefrom in two desired directions. The settings include driver's seat only mode 130 and driver's seat and passenger's seat mode 131. Each air blowing motor 105 is preferably formed as high-speed electric fan 106.

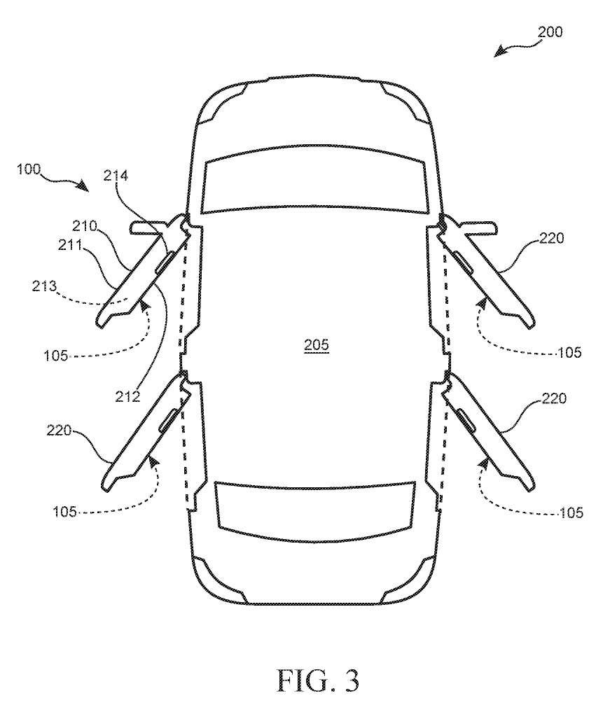

Referring now to FIG. 3, is a perspective view illustrating combination of a motor vehicle and a shoe cleaning system 200 according to an embodiment of the present invention of FIG. 1.

Combination of a motor vehicle and a shoe cleaning system 200 may comprise motor vehicle 205 including driver's door 210 having exterior panel member 211, interior panel member 212, and interior volume 213 in between exterior panel member 211 and interior panel member 212, at least one passenger's door 220 with each one including exterior panel member 211, interior panel member 212, and interior volume 213 in between exterior panel member 211 and interior panel member 212, at least one control console 214, and shoe cleaning system 100.

Shoe cleaning system 100 comprises a plurality of air blowing motors 105 located within interior volume 213 of each of door members 110, a plurality of air hoses 115 located within interior volume 213 of each of door members 110 that are attached to respective air blowing motor 105 and adapted to receive air from air blowing motors 105 through proximal end 116 and exhaust air through distal end 117 thereof.

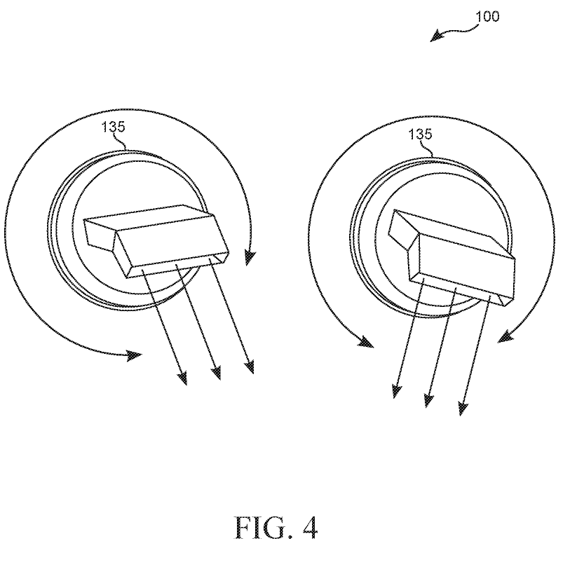

Referring now to FIG. 4, is a perspective view illustrating rotatable louver member 135 of shoe cleaning system 100 according to an embodiment of the present invention of FIG. 1.

Rotatable louver member 135 is connected to distal end 117 of its respective air hose 115 and is adapted to direct the air exhausting from distal end 117 in a desired direction. Control member 125 is adapted to be connected to interior surface 112 of motor vehicle 205 and is electrically connected to each of air blowing motors 105 to turn on and off each one individually. When in use, a person can sit upon the seat within motor vehicle 205 with their feet still outside motor vehicle 205 and turn on a respective air blowing motor 105 to clean their shoes before entering motor vehicle 205.

There is at least one rotatable louver member 135 connected to interior surface 112 of each of door members 110 and each rotatable louver member 135 are connected to distal end 117 of each respective air hose 115 and is adapted to direct the air exhausting from distal end 117 in a desired direction. Control member 125 is connected to interior surface 112 of control console 214 and is electrically connected to each of air blowing motor 105 and is adapted to turn on and off each air blowing motor 105 individually.

When in use, a person can sit upon the seat of motor vehicle 205 with their feet still outside motor vehicle 205 and turn on the respective air blowing motor 105 to clean their shoes before entering motor vehicle 205. Control member 125 may be formed as rotary knob 126 having a plurality of settings adapted to control which air blowing motor 105 is turned on or off. The settings include driver's seat only mode 130 and driver's seat and passenger's seat mode 131.

Shoe cleaning system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be appreciated that, under appropriate circumstances, considering such issues as design preference, user preferences, marketing preferences, cost, structural requirements, available materials, technological advances, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A shoe cleaning system for use with motor vehicles, comprising:
at least one air blowing motor;
wherein each said at least one air blowing motor is adapted to be located within a respective door member of said motor vehicle;
at least one air hose;
wherein said at least one air hose is adapted to be located within a respective said door member of said motor vehicle; and
wherein each said air hose is attached to a respective said air blowing motor and adapted to receive air from said air blowing motor through a proximal end and exhaust air through a distal end thereof;
at least one rotatable louver member;
wherein said at least one rotatable louver member is adapted to be connected to an interior surface of a respective said door member of said motor vehicle; and
wherein said at least one rotatable louver member is connected to a distal end of a respective said at least one air hose and is adapted to direct said air exhausting from said distal in a desired direction; and
a control member;
wherein said control member is adapted to be connected to an interior surface of said motor vehicle, is electrically connected to each of said at least one air blowing motor, and is adapted to turn on and off each said at least one air blowing motor individually;
wherein when in use a person can sit upon a seat within said motor vehicle with their feet still outside said motor vehicle, turn on a respective air blowing motor, and clean their shoes before entering said motor vehicle.

2. The shoe cleaning system of claim 1, wherein said control member is formed as a rotary knob including a plurality of settings adapted to control which of said at least one air blowing motor is turned on or off.

3. The shoe cleaning system of claim 2, wherein said plurality of settings includes a driver's seat only mode and a driver's seat and passenger's seat mode.

4. The shoe cleaning system of claim 1, wherein each said at least one air hose has an air hose extension attached to a middle section thereof and is adapted to receive air from said air blowing motor through a proximal end and exhaust air through a distal end thereof; and wherein there are two rotatable louver members adapted to be connected to an interior surface of a respective said door member of said motor vehicle in a spaced fashion; and wherein said two rotatable louver members are connected to respective distal ends of said at least one air hose and said air hose extension and are adapted to direct said air exhausting therefrom in two desired directions.

4. The shoe cleaning system of claim 2, wherein plurality of settings includes a driver's seat only mode and a driver's seat and passenger seats mode.

5. The shoe cleaning system of claim 1, wherein each said at least one air blowing motor is formed as a high-speed electric fan.

6. A combination of a motor vehicle and a shoe cleaning system, comprising:
a motor vehicle including:
a driver's door including;
an exterior panel member;
an interior panel member; and
an interior volume in between said exterior panel member and said interior panel member;
at least one passenger's door, each including:
an exterior panel member;
an interior panel member; and
an interior volume in between said exterior panel member and said interior panel member; and
and at least one control console; and
a shoe cleaning system comprising:
a plurality of air blowing motors;
wherein one air blowing motor is located within said interior volume of each of said driver's door and said at least one passenger's door;
a plurality of air hoses;
wherein one air hose is located within said interior volume of each of said driver's door and said at least one passenger's door and is attached to a respective said air blowing motor and adapted to receive air from said respective air blowing motor through a proximal end and exhaust air through a distal end thereof;
at least one rotatable louver member;
wherein at least one rotatable louver member is connected to said interior surface of each of said driver's door and said at least one passenger's door; and
wherein each said at least one rotatable louver member is connected to a distal end of a respective said air hose and is adapted to direct said air exhausting from said distal in a desired direction; and
a control member;
wherein said control member is connected to an interior surface of one of said at least one control console, is electrically connected to each of said air blowing motor, and is adapted to turn on and off each said air blowing motor individually;
wherein when in use a person can sit upon a seat within said motor vehicle with their feet still outside said motor vehicle, turn on a respective air blowing motor, and clean their shoes before entering said motor vehicle.

7. The shoe cleaning system of claim 6, wherein said control member is formed as a rotary knob including a plurality of settings adapted to control which said air blowing motor is turned on or off.

8. The shoe cleaning system of claim 7, wherein said plurality of settings includes a driver's seat only mode and a driver's seat and passenger's seat mode.

9. The shoe cleaning system of claim 6, wherein each said air hose has an air hose extension attached to a middle section thereof and is adapted to receive air from a respective air blowing motor through a proximal end and exhaust air through a distal end thereof; and wherein there are two rotatable louver members connected to said interior surface of each respective said driver's door and said at least one passenger's door in a spaced fashion; and wherein each said two rotatable louver members are connected to respective distal ends of each said air hose and said air hose extension and are adapted to direct said air exhausting therefrom in two desired directions.

10. The shoe cleaning system of claim 6, wherein each said at least one air blowing motor is formed as a high-speed electric fan.
